(19) United States
(12) Patent Application Publication
(10) Pub. No.: US 2022/0336882 A1
(43) Pub. Date: Oct. 20, 2022

(54) METHOD FOR AVOIDING THE PROPAGATION OF A THERMAL EVENT IN AN ENCLOSURE COMPRISING SEVERAL MODULES OF ELECTROCHEMICAL CELLS

(71) Applicant: SAFT, Levallois-Perret (FR)

(72) Inventors: Gilles HELSCHGER, BORDEAUX (FR); Christophe LE GUERN, BORDEAUX (FR); Jean-Louis LISKA, SAINT MEDARD EN JALLES (FR); Christophe MORIN, SAINT AUBIN DE MEDOC (FR)

(73) Assignee: SAFT, Levallois-Perret (FR)

(21) Appl. No.: 17/765,534

(22) PCT Filed: Oct. 3, 2019
(86) PCT No.: PCT/FR2019/052345

§ 371 Date: Mar. 31, 2022

(51) Int. Cl. H01M 10/63; H01M 10/613; H01M 10/6567; H01M 10/6569; H01M 10/48

(52) U.S. Cl. CPC H01M 10/63; H01M 10/613; H01M 10/6567; H01M 10/6569; H01M 10/486

(57) ABSTRACT

A method for avoiding the spread of a thermal event in an enclosure containing several modules (1, 2, 3, 4) of electrochemical elements, said method comprising the following steps: —detecting one or more critical modules (1, 2, 3) situated in the enclosure, and affected by a thermal event (13), a module being critical when one or more parameters associated with the status of the module have reached or crossed a predetermined threshold, —spraying a coolant (12) onto, or into, the critical module or modules (1, 2, 3) for a determined duration and/or at a determined flow rate, one or more modules (4) not detected as being critical modules not receiving any coolant (12).

### FIELD OF THE INVENTION

The invention relates to the technical field of methods for avoiding the propagation of a thermal event in an enclosure comprising several modules of electrochemical cells.

### BACKGROUND ART

A battery module, designated below as a “module”, is known from the prior art. It generally comprises several electrochemical cells, also referred to in the following by the term “cell”, electrically connected to each other, in series or in parallel, by means of metal bars. These metal bars have a cross section sufficient to allow high current flow between the cells of the module. The module also generally comprises an electronic circuit for monitoring and managing the cells, for measuring their state of charge and/or their state of health, in particular by means of voltage or current measurements taken individually cell by cell or taken on a group of cells. The module may also include a temperature control device.

A plurality of battery modules may be connected together in series and/or in parallel and installed in a bay, also referred to as a rack. The dimensions of the bay are generally standardized. For example, a bay may have a standard width of 48.26 cm (a 19 inches bay). This bay constitutes an Electrochemical Storage Unit, also called an “Electrochemical Storage System Unit (ESSU)”. A plurality of bays may be connected in parallel to increase the amount of electrical energy. The set of bays may be stored in a room of a building or in a transport container. The transport container may be moved and installed proximate renewable energy sources, such as photovoltaic cells or wind turbines. It stores electricity generated by these energy sources and renders it in the form of a power supply to electrical or electronic systems. The container is called an Electrochemical Storage System or Energy Storage System (ESS).

A cell of a module of a bay installed in an electrochemical storage system may experience an operating anomaly. This anomaly may be caused by an internal short circuit of the cell, or by an external disturbance (impact, rise of temperature) or by a failure of the electronic control and management circuit of the cell. This anomaly may cause it to heat up. This heating may in turn cause an increase in the charging current that further promotes an increase in the temperature of the cell. If the operating anomaly cell is not dealt with sufficiently by cooling, it finds itself in a thermal runaway situation, that is, the temperature rise is maintained by the cell itself. The uncontrolled increase in the temperature of a cell results in the generation of gases and their expansion within the container of the cell. This expansion causes an increase in the internal pressure in the cell, which will cause the opening of a gas evacuation safety system. In the event of the release of hot gases, the temperature of which can reach 650° C., these gases come into contact with the other cells housed in the module. There is a risk of the thermal runaway phenomenon propagating to all of the cells of the module, then to all modules of a bay, and finally to all the bays of the electrochemical storage system. If no means exists to prevent propagation of the thermal runaway, the entire electrochemical storage system can be destroyed.

A means for reducing the risk of propagation of thermal runaway from one module cell to another component of the module consists in providing a sufficient space between these cells or installing a material acting as a thermal barrier between these cells. However, this solution requires a sufficient space between the cells and leads to the production of bulky modules. It thus penalizes the energy density of the module.

Another means includes providing a fire extinguishing system (Fire Suppression System—FSS). Such a system projects a fire-extinguishing agent onto the one or more modules in a thermal runaway situation. It generally utilizes a coolant that is liquid carbon dioxide or liquid nitrogen.

EP-A-1,168,479 discloses a battery comprising a case in which eight electrochemical cells of the lithium-ion type are housed. When a cell heats up and its temperature exceeds a limit value, a pyrotechnic device triggers and controls the opening of a storage vessel containing an extinguishing agent. The extinguishing agent is released for the purpose of cooling the battery. In this document, the cells are all cooled by the extinguishing agent regardless of their distance from the cell in a situation of thermal runaway.

CN 106684499 discloses a method for stopping thermal runaway in a battery comprising lithium-ion cells/modules. The battery includes a housing in which the cells/modules are housed. A storage vessel filled with a fire extinguishing agent is disposed therein. A conduit is connected at one end to the storage vessel. The conduit is provided with a plurality of nozzles regularly distributed along the length of the conduit. The nozzles spray the extinguishing agent above the cells/modules.

The method described in this document does not perform differentiated processing of the modules depending on whether they are located near the initiator module of the thermal runaway or they are remote from the initiator module of the thermal runaway. A cell/module remote from the thermal runaway initiating cell/module is sprayed with extinguishing agent in the same manner as the thermal runaway initiating cell/module. In addition, in this document the thermal runaway cell/module is sprayed with extinguishing agent for the purpose of stopping thermal runaway. However, it is found that sprinkling of an extinguishing agent on a lithium-ion type cell/module already in thermal runaway situation is relatively ineffective, because a very large amount of energy is stored in a lithium ion type cell/module. The amount of energy released as heat in the event of an opening of the container of the cell/module is so great that the flow rate of the extinguishing agent is generally insufficient to neutralize the temperature increase, this enormous amount of energy being released abruptly over a short period of time. If the thermal runaway of the module is not controlled, it propagates to the neighboring modules and can lead to the total destruction of the storage system.

In addition, the known fire extinguishing systems are not fully effective because the propagation of thermal runaway is not only due to the propagation of flames from one cell to another but also due to the propagation of heat by convection and by conduction from one cell to another. The conduction of heat by conduction is explained by the presence of the metal bars of the power circuit of the module cells and also by the presence of electronic circuits for managing the state of charge and the state of health of the cells of the module. These metal components promote the transmission of heat from one member to another. In addition, conventional fire extinguishing systems are generally ineffective due to the fact that thermal runaway occurring in a module leads to overpressure in the module's casing due to generation of the gases. This overpressure prevents the extinguishing agent from entering into the module casing and acting effectively.

There is therefore a need for a method that makes it possible to avoid, under the assumption of the occurrence of thermal runaway or any other event generating a sudden increase in temperature in one or more modules of an enclosure, this thermal event propagating to the other modules disposed in this enclosure.

There is also a need for a method of avoiding the propagation of a thermal event by thermal conduction between the modules of the enclosure.

There is also a need to limit the risk of a thermal event occurring again over a long period of time, after mastery/control of a first thermal event.

### SUMMARY OF THE INVENTION

Thus, the invention provides a novel method for preventing the propagation of a thermal event in an enclosure comprising several modules of electrochemical cells, said method comprising the following steps:
detecting one or more critical modules disposed in the enclosure, affected by a thermal event, wherein a module is critical when one or more parameters related to the state of the module have reached or exceed a predetermined threshold,
dispensing of a coolant onto, or into, the one or more critical modules, for a determined duration and/or at a determined flow rate,

one or more modules that are not detected as critical modules not receiving a coolant.

The thermal event may have been initiated by one or more modules of the enclosure or may have been initiated in a location of the enclosure not occupied by one or more modules. The thermal event may be thermal runaway in one or more modules of the enclosure, such as one due to the occurrence of an internal short circuit in a cell of a module. The thermal event may also be the start of a fire in the enclosure, without necessarily the fire being caused by the occurrence of thermal runaway from a module. The thermal event may also be overheating of one or more modules, which overheating may be caused by malfunction of the module cooling system. Overheating may also be caused by a malfunction of the air conditioning system of the enclosure or by a malfunction of the charging device of the modules and an overcharging of one or more modules. More generally, the thermal event may be any temperature rise in a location of the enclosure, which results in the temperature of one or more modules to beyond the maximum value of their nominal operating range.

The invention is based on the discovery that it is possible to prevent the propagation of a thermal event by cooling the one or more modules likely to be affected by a thermal event that occurred in one or more other given modules of the enclosure or that occurred in a location of the enclosure not occupied by one or more modules. By dispensing a coolant into or onto the modules that are likely to be affected by the thermal event, it is possible to maintain the temperature of these modules at a value below a threshold value beyond which they would be likely to be subject to a thermal event. Thus, it is possible to prevent a thermal event that was initially produced in one or more given modules or that has occurred in a location of the enclosure not occupied by one or more modules, from being at the origin of the start of new thermal events.

The invention is based on the discovery that it is preferable to cool the neighboring modules of the at least one module subject to the thermal event or adjacent to the location of the enclosure in which the thermal event has occurred, rather than attempting to extinguish the fire in the module in the event of a thermal event.

The method of the invention solves the problem of heat conduction by thermal conduction between one or more given modules.

In one embodiment, the one or more parameters include the temperature within the one or more modules, wherein one or more modules are considered critical when the temperature of the one or more modules exceeds a predetermined threshold value Ts.

In one embodiment, the one or more parameters include the presence of smoke and/or gas within the one or more modules, wherein one or more modules are considered critical when the concentration of smoke and/or gas exceeds a predetermined value.

In one embodiment, in the event of a thermal event initiated by one or more modules of the enclosure, a duration and/or flow rate is determined so that the temperature of the at least one critical module is maintained below a threshold temperature Tₘₐₓ, except for the module(s) that initiated the thermal event.

According to one embodiment, the determined duration is greater than or equal to 1 hour, preferably greater than or equal to 2 hours, and preferably less than or equal to 12 hours.

According to one embodiment, the coolant is a compound whose cooling effect is mainly obtained by a transition from a liquid phase to a gaseous phase, in particular a water or carbon dioxide or nitrogen mist.

In one embodiment, each module includes a casing having an outer surface and dispensing of the coolant is performed on the outer surface.

According to one embodiment, each module comprises a casing defining an interior volume in which electrochemical cells are housed and dispensing of the coolant is performed by injection into said interior volume.

In one embodiment, the coolant is stored in liquid form in a storage vessel.

In one embodiment, detection of one or more critical modules is performed using one or more sensing means disposed in, on or near each module of the enclosure, the one or more sensing means being a temperature threshold sensing means and/or a temperature sensor and/or a smoke or gas detector.

In one embodiment, when the sensing means detect one or more critical modules, dispensing of the coolant onto, or into, the one or more critical modules is triggered in an immediate or a delayed manner.

In one embodiment, when the sensing means detect one or more critical modules, it sends a signal to a central device that controls the dispensing of the coolant onto, or into, the one or more critical modules.

The invention also provides an installation for implementing the method as described above, said installation comprising several modules of electrochemical cells, each module being equipped with sensing means able to detect whether the module is a critical module affected by a thermal event, a module being critical when one or more parameters related to the state of the module have reached or exceed a predetermined threshold, the installation comprising dispensing means, for a determined duration and/or flow rate, of a coolant onto, or into, the critical module(s) detected by the sensing means, one or more modules which are not detected as critical by the sensing means not receiving a coolant.

According to one embodiment, the installation comprises means for controlling the dispensing rate, the coolant being a water mist, and the means for controlling the dispensing rate being configured so that the determined flow rate per critical module is between 0.1 and 2 kg/h by kWh of electric energy stored in the critical module.

According to one embodiment, the dispensing means comprise a storage vessel, a distribution network, and a plurality of dispensing devices arranged on, in, or proximate to each module of the enclosure, the coolant being stored in the storage vessel, the storage vessel being connected to the dispensing devices via the distribution network.

According to one embodiment, the dispensing means comprise a central device for controlling the dispensing of the coolant, configured to receive a signal, generated by the sensing means, and to trigger the dispensing of the coolant onto, in or near the critical modules upon receipt of a detection signal of a thermal event.

### BRIEF DESCRIPTION OF THE DRAWINGS

FIG. 1 is a diagrammatic representation of the installation according to the invention.

FIG. 2 is a diagrammatic representation of the dispensing of a coolant onto the outer surface of a critical module.

FIG. 3 is a diagrammatic representation of the dispensing of a coolant into a critical module and on the outer surface of the critical module.

FIG. 4 diagrammatically illustrates the structure of the installation in an example of the active operation of the distribution network.

### DETAILED DESCRIPTION OF EMBODIMENTS

Description of the Method:

The method according to the invention aims to avoid the propagation of a thermal event in an enclosure comprising a plurality of modules of electrochemical cells. The enclosure may be a room of a building, or a room dedicated to storing bays of electrochemical cell modules. The enclosure may also be a transport container, a prefabricated shelter for using the modules as a backup power source, for example for electrical/electronic equipment in the telecommunications field. The container can also be used in systems for transporting people or goods, for example by rail. The container may have standardized dimensions according to an ISO standard.

Detection of the one or more modules considered critical as a result of them receiving heat, smoke or hot gases generated from the location of the thermal event is performed. These modules are considered critical as likely to be affected by the thermal event. A module is considered to be critical if one or more parameters related to its state reach or exceed a predetermined threshold. The state parameter may be selected from the temperature of the module, the amount of smoke, or the concentration of gas present around the module.

Detection of the critical state of a module is performed using one or more sensing means selected from temperature sensors, smoke detectors, and gas sensors. In the case of temperature sensors, one or more temperature sensors may be disposed on the surface of each module or in each module. One or more temperature sensors may additionally be disposed on the surface of the module cells to ensure even earlier detection of the critical state of the module. The temperature threshold value Ts beyond which it is considered that a module is in a critical state is predetermined by an operator. It can be set at 150° C. or 200° C. or at 250° C. or at 300° C. In addition, one or more temperature sensors may be placed at different locations within the enclosure, preferably as close as possible to the modules.

The detection of the critical state can also be achieved by means of gas or smoke detectors. One or more sensors are preferably positioned proximate the modules but may also be placed at various locations in the enclosure, such as the ceiling. For example, a sensor is selected responsive to the presence of gases from the combustion of components of the module, such as gases resulting from the combustion of the electrolyte of the cells of the module. The threshold value of gas concentration beyond which a module is considered to be in a thermal event situation may be predetermined by an operator.

The modules adjacent the module(s) that initiated the thermal event or located near the location of the enclosure in which the thermal event was declared are generally considered critical. In a configuration in which the modules form a stack and are installed in a bay, several bays are placed next to each other, the critical modules generally being:
the module(s) located above the module(s) that initiated the thermal event,
the at least one module located below the at least one initiator module of the thermal event,
the module(s) of a bay which are at the same height as the module(s) that initiated the thermal event, for example those which are located on another bay to that in which the at least one initiator module of the thermal event is located,
the module(s) located diagonally with respect to the module(s) that initiated the thermal event.

A coolant is dispensed onto, or into, the one or more critical modules, for a determined duration and/or flow rate. Administration of the coolant may be performed by emission of gas directed into or around the one or more critical modules. It can also be carried out by spraying a coolant in the liquid state. Preferably, the cooling effect is obtained by passing from a first physical state of the coolant to a second physical state. The flow of heat generated by the thermal event transforms the coolant for example from the solid state to the liquid state or from the liquid state to the gaseous state. A coolant having a high latent heat of change of state is preferably selected. The coolant is preferably selected from water, carbon dioxide and nitrogen, or any other coolant, such as the one known as NOVEC® or STAT-X® (https://statx.com/).

One of the features of the method according to the invention is that it performs dispensing of the coolant with a lower flow rate than in conventional methods, over a generally longer period of time. This dispensing mode makes it possible to create a cold barrier around or in the modules considered critical. The cold barrier prevents heat flow or fumes, or hot gases generated by the thermal event from reaching the critical modules and cause damage to the critical modules. The cold barrier can further cool the critical modules and maintain their temperature within a range in which they cannot in turn initiate a thermal event. The maximum value Tₘₐₓ of this temperature range is related to the technology of the constituent cells of the module. It can be set at 120° C. or at 100° C. for example, the coolant can be dispensed for a period of time greater than or equal to 1 hour, preferably greater than or equal to 2 hours. It can be dispensed for a period of less than or equal to 12 hours or less than or equal to 5 hours. In one embodiment, the temperature of the one or more critical modules is maintained below the maximum value of their nominal operating range set by the manufacturer.

The flow rate of the coolant and the time of dispensing depend on the amount of heat generated by the electrochemical cells of the module that initiated the thermal event or generated by a thermal event occurring at a location of the enclosure not occupied by one or more modules and thus not initiated by the one or more modules. In the event of a module-initiated thermal event, this amount of heat is dependent on the technology of the module and its size. Typically, the coolant is a water mist, and the dispensing rate is between 0.1 and 2 kg/h per kWh of electrical energy stored in the critical module and per critical module.

It should be noted that in the case of a thermal event initiated by one or more modules, these modules are also considered to be critical modules because the value of their state parameter is always greater than the predetermined threshold Ts. Accordingly, the one or more initiator modules of the thermal event may also receive the coolant, although the flow rate or dispensing duration of the coolant is insufficient to terminate the thermal event that it or they is/are originating. The method generally processes the one or more initiator modules of the thermal event and the one or more modules that have reached a critical state.

In a preferred embodiment, the one or more modules that initiated thermal runaway do not receive a coolant since it is often pointless to attempt to extinguish the fire in a thermal runaway module. Therefore, the method according to the invention is not intended to extinguish the fire in the module(s) that initiated the thermal event but rather to prevent modules likely to be affected by the thermal event suffering in their turn a thermal event and to prevent it propagating.

Another feature of the method according to the invention is that one or more modules considered to be non-critical, i.e. whose parameters related to their state are less than a predetermined threshold, do not receive a coolant. The method according to the invention therefore performs differentiated processing of the modules as a function of the risk that they have of being affected by the thermal event. Generally, this risk decreases with distance from the one or more initiator modules of the thermal event, or from the location in the enclosure not occupied by modules in which the thermal event has occurred. This feature has the advantage of reducing the amount of coolant used with respect to the required amounts in a conventional fire extinguishing process. Conventional methods require the provision of a large amount of extinguishing agent, which requires the use of large capacity storage tanks, which is expensive.

Description of an Installation

There will now be described an installation specially designed for the implementation of the method as described above. The installation comprises a plurality of electrochemical cell modules 1, 2, 3, 4. The modules are arranged in modular structures, also referred to as a bay or rack. Generally, the modules are stacked on top of each other and secured to vertical uprights of the bay. Electrical connections connect in series a plurality of modules of a same bay to increase the voltage that a bay may deliver. A bay is an electrochemical storage unit. A plurality of bays are disposed in the enclosure. They may be connected together in parallel to increase the amount of electricity available. The set of bays of the enclosure constitutes an electrochemical storage system.

Each module is equipped with one or more means 5 for sensing a state parameter. The at least one sensing means may be located on an outer surface of a casing of a module or be within the interior volume defined by the housing. The sensing means may be a temperature sensor, a detector of a particular chemical compound, a flame or smoke detector or any other type of sensing means adapted to detect an anomaly in the operation of a module.

The installation comprises means for dispensing the coolant. These include a coolant storage vessel 6, a coolant distribution network 7, 8 and coolant delivery devices 9 to the modules.

The coolant is stored in a storage vessel 6. It is supplied to the modules by means of the distribution network. The distribution network comprises a conduit system 7 which is subdivided into different branches 8. One end of the conduit system is connected to the coolant storage vessel. Each branch is provided at its end with a device 9 for dispensing the coolant. The dispensing device may be located proximate to or in contact with a module. It may discharge onto the exterior surface of the module or discharge within the volume defined by the casing of the module.

When the at least one sensing means of a module detects a changeover of a module to a critical state, the coolant stored in the storage vessel is released into the distribution network and fed under pressure to the dispensing device associated with the critical module.

The branches of the conduit system can operate actively. For example, one or more sensing means detect a changeover of a module to the critical state. They send a signal to a central device for controlling dispensing of the coolant. The central controller initiates dispensing of the coolant onto, in, or near the one or more critical modules. The central control device may for example control the opening of a valve located on the conduit system.

According to the invention, the dispensing of the coolant does not occur on the module(s) which are not considered critical; it is therefore possible to use a storage vessel of smaller capacity than for a conventional installation in which the dispensing of the coolant onto the modules occurs in an undifferentiated manner. In addition, the invention makes it possible to preserve the modules considered to be non-critical from contact with the coolant.

When the sensing means 5 detect one or more critical modules 1, 2, 3, the dispensing of the coolant 12 onto, or into the one or more critical modules 1, 2, 3 is triggered in an immediate or delayed manner. A period of time of a few minutes to a maximum time of an hour to trigger the dispensing of the coolant can be set in order to limit the volume of coolant used. Delayed spraying of the coolant may be of interest in the event that the rate of propagation of the heat from one module to another is relatively slow.

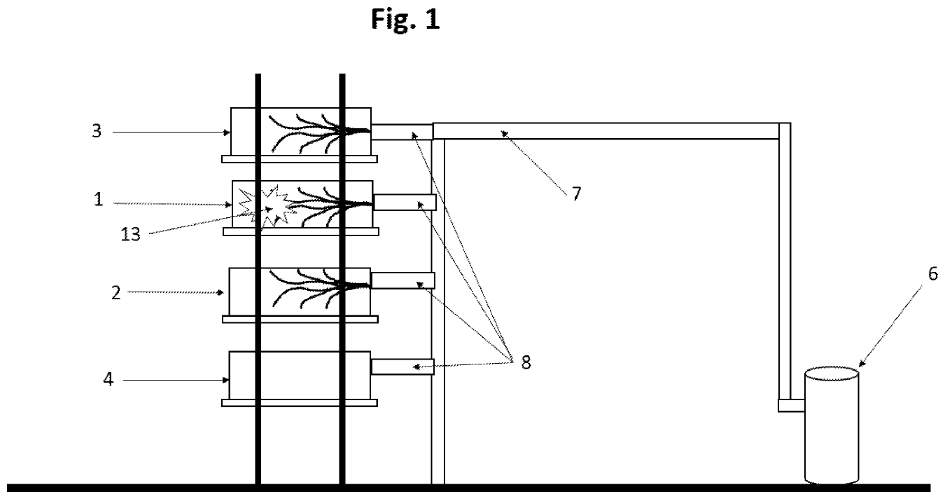

FIG. 1 illustrates an example of the installation according to the invention. It represents a side view of a module bay resting on the ground of an enclosure. The bay includes two parallel vertical uprights and four horizontal trays attached to the two vertical uprights. Each horizontal plate serves as a support for a module 1, 2, 3, 4. The trays and modules are four in number in FIG. 1, but it will be understood that their number is not limited. The coolant is stored in a storage vessel 6. The distribution network consists of a conduit system 7 which is subdivided into four branches 8. One end of the conduit system is connected to the coolant storage vessel. Each branch discharges onto a side surface of a module. In the example, module 1 initiated a thermal event 13. It is considered to be critical. As a result of the propagation of heat from the module 1 to the neighboring modules 2, 3, these are also considered to be critical. The module 4 is not considered to be critical because its temperature remains below the threshold value Ts due to its greater distance from the module 1 than modules 2 and 3. A coolant is injected only into the critical modules, i.e., modules 1, 2 and 3.

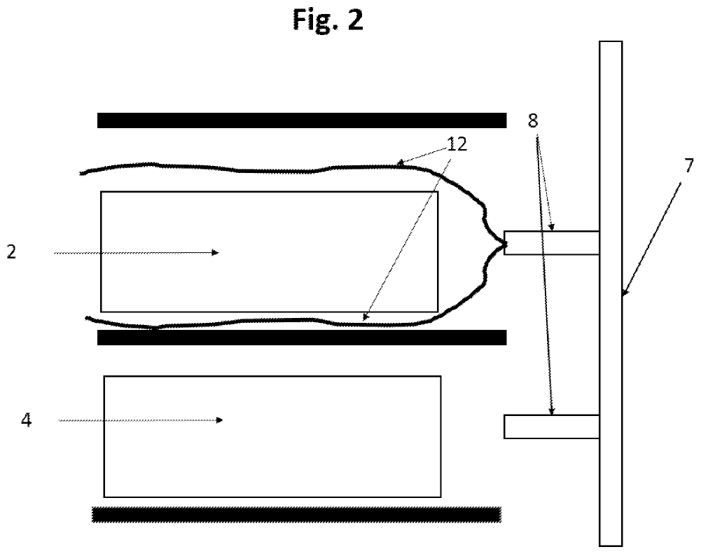

FIG. 2 is a diagrammatic representation of the dispensing of a coolant around the outer surface of a critical module 2. The ends of the branches 8 of the distribution network 7 are arranged close to the modules 2 and 4. A space has been formed when installing the modules in the bay to allow circulation of the coolant above the module, below the module and around its lateral surface. Circulation of the coolant 12 creates a cold barrier around the outer surface of the critical module 2.

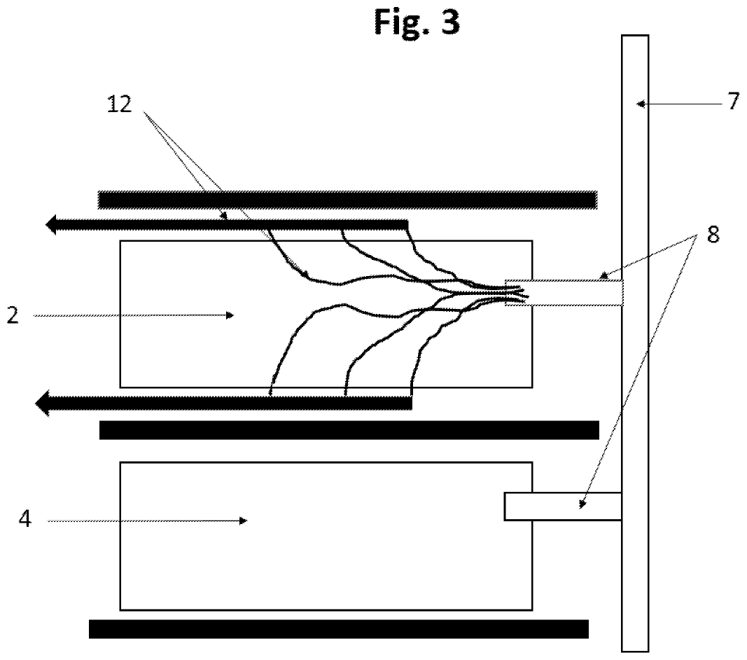

FIG. 3 is a diagrammatic representation of the dispensing of a coolant inside a module considered critical 2 and then around its casing. The ends of the branches 8 of the distribution network 7 are integrated with the modules 2 and 4. The coolant enters the interior of the volume of the module and then exits through one or more openings in the module. As a result of these openings, the coolant 12 creates a cold barrier around the casing of the critical module 2.

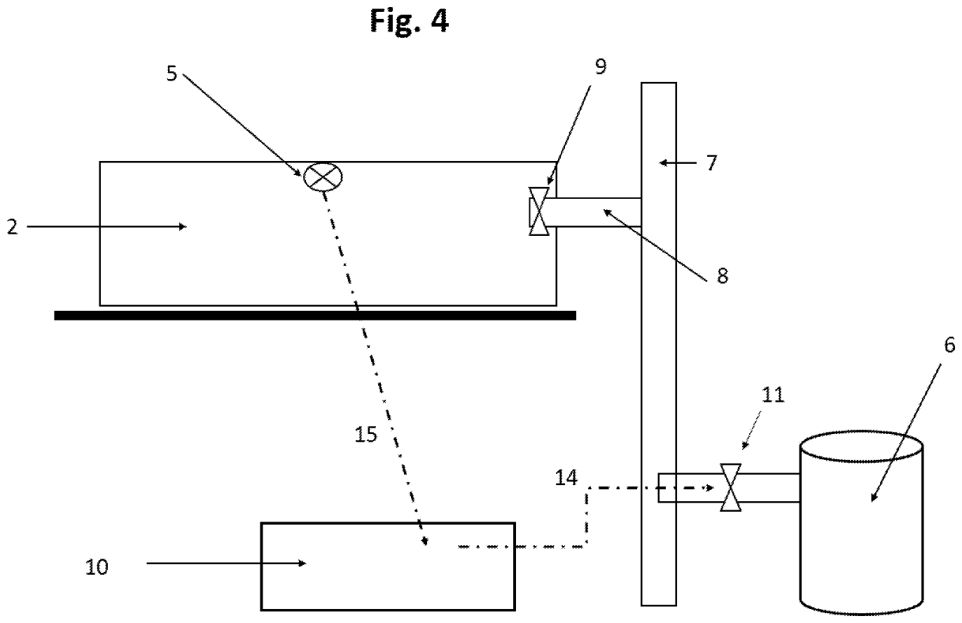

FIG. 4 diagrammatically illustrates a possible configuration of the installation in the event of active operation of the distribution network. A sensing means 5 of the critical state of the module 2 is arranged in contact with the inner surface of the upper wall of the module casing. The sensing means could be located at another location within the volume defined by the module casing. It could also be located outside the module or near the module or on an outer surface of the wall of the module casing. In the event of the detection of a critical state of the module, the sensing means 5 sends a signal 15 to a centralization system 10 which controls, by a signal 14, the opening of a valve 11 arranged on the conduit system of distribution network 7. This causes the coolant 6 to flow in the direction of the branch 8 to the critical module 2. The branch is provided at its end with a device 9 for dispensing the coolant. This embodiment makes it possible to only keep the coolant storage vessel under pressure and not the conduit system of the distribution network. It is the opening of the valve which makes it possible to put the conduit system of the distribution network under pressure.

1. A method for preventing the propagation of a thermal event in an enclosure comprising several electrochemical cell modules, said method comprising the following steps:
detecting one or more critical modules arranged in the enclosure, which are affected by a thermal event, a module being critical when one or more parameters related to the state of the module have reached or exceed a predetermined threshold,
dispensing a coolant onto, or into, the at least one critical module, for a determined duration and/or at a determined flow rate,
one or more modules that are not detected as critical modules not receiving a coolant.

2. The method of claim 1, wherein said at least one parameter comprises a temperature within the one or more modules, wherein one or more modules are considered critical when the temperature of the one or more modules exceeds a predetermined threshold value Ts.

3. The method according to claim 1, wherein said at least one parameter comprises the presence of smoke and/or gas within the at least one module, wherein one or more modules are considered critical when the concentration of smoke and/or gas exceeds a predetermined value.

4. The method according to claim 1, wherein, in the event of a thermal event initiated by one or more modules of the enclosure, duration and/or coolant flow rate are determined so that the temperature of the at least one critical module is maintained below a threshold temperature Tₘₐₓ, except for the module(s) that initiated the thermal event.

5. The method according to claim 1, wherein the determined duration is greater than or equal to 1 hour, preferably greater than or equal to 2 hours, and preferably less than or equal to 12 hours.

6. The method according to claim 1, wherein the coolant is a compound whose cooling effect is mainly obtained by the transition from a liquid phase to a gaseous phase, in particular a water or carbon dioxide or nitrogen mist.

7. The method according to claim 1, wherein each module comprises a casing having an outer surface and the dispensing of the coolant is carried out on said outer surface.

8. The method according to claim 1, wherein each module comprises a casing defining an internal volume in which electrochemical cells are housed, and the dispensing of the coolant is carried out by injection into said internal volume.

9. The method according to claim 1, wherein the coolant is stored in liquid form in a storage vessel.

10. The method according to claim 1, wherein the detection of one or more critical modules is carried out by means of one or more sensing means arranged in, on or near each module of the enclosure, the at least one sensing means being a temperature threshold sensing means and/or a temperature sensor and/or a smoke or gas detector.

11. The method according to claim 10, wherein when the sensing means detects one or more critical modules, the dispensing of the coolant onto, or into, the one or more critical modules is triggered in an immediate or delayed manner.

12. The method according to claim 10, wherein when the sensing means detects one or more critical modules, it sends a signal to a central device which controls the dispensing of the coolant onto, or into, the one or more critical modules.

13. An installation for implementing the method according to claim 1, said installation comprising several electrochemical cell modules, each module being equipped with sensing means able to detect whether the module is a critical module affected by a thermal event, a module being critical when one or more parameters related to the state of the module have reached or exceed a predetermined threshold, the installation comprising dispensing means, for a determined duration and/or at a determined flow rate, of a coolant onto, or into, the critical module(s) detected by the sensing means, one or more modules which are not detected as critical by the sensing means not receiving a coolant.

14. The installation according to claim 13, wherein it comprises means for controlling the dispensing rate, the coolant being a water mist, and the means for controlling the dispensing rate being configured so that the determined flow rate per critical module is between 0.1 and 2 kg/h per kWh of electrical energy stored in the critical module.

15. The installation according to claim 13, wherein the dispensing means comprise a storage vessel, a distribution network, and a plurality of dispensing devices arranged on, in, or close to each module of the enclosure, the coolant being stored in the storage vessel, the storage vessel being connected to the dispensing devices via the distribution network.

16. The installation according to claim 13, wherein the dispensing means comprise a central device for controlling the dispensing of the coolant, configured to receive a signal, generated by the sensing means, and to trigger the dispensing of the coolant onto, into or near the critical modules upon reception of a detection signal of a thermal event.
